(19) United States
(12) Patent Application Publication
(10) Pub. No.: US 2024/0136542 A1
(43) Pub. Date: Apr. 25, 2024

(54) GRAPHITE METAL COMPOSITES FOR FUEL CELL BIPOLAR PLATES

(71) Applicant: Advent Technologies, LLC, Livermore, CA (US)

(72) Inventors: Ru CHEN, Dublin, CA (US); Ian W. KAYE, Livermore, CA (US); Emory S. DE CASTRO, Nahant, MA (US)

(21) Appl. No.: 18/489,297

(22) Filed: Oct. 17, 2023

Related U.S. Application Data
(60) Provisional application No. 63/418,323, filed on Oct. 21, 2022.

(51) Int. Cl. H01M 8/0243; H01M 8/0206; H01M 8/0228; H01M 8/0234

(52) U.S. Cl. CPC H01M 8/0243; H01M 8/0206; H01M 8/0228; H01M 8/0234; H01M 2008/1095

(57) ABSTRACT

A fuel cell system bipolar plate formed of a graphite metal composite. The bipolar plate is formed of a metal foil formed of tantalum or a metal having a tantalum coating. Flexible graphite deposited in rows on each surface of the metal foil forms channels of the bipolar plate and providing a flow field. The graphite metal composite provides flexural strength as well as resistance to corrosion.

### RELATED APPLICATION

This application claims the benefit of U.S. Provisional Application No. 63/418,323, filed on Oct. 21, 2022. The foregoing application is hereby incorporated by reference herein for all purposes.

### BACKGROUND OF THE INVENTION

The present disclosure generally relates to fuel cells. More specifically, the disclosure relates to bipolar plates in fuel cells.

Fuel cells are electrochemical devices that can be used in a wide range of applications, including transportation, material handling, stationary, and portable power applications. Fuel cells use fuel and air to generate electricity by electrochemical reactions and release reaction byproducts as exhaust. In fuel cells, each of the membrane electrode assemblies (MEAs) is sandwiched between two bipolar plates to separate the MEA from neighboring MEAs. The MEAs are typically connected in series to provide sufficient output voltage for the stack. Bipolar plates and MEAs are assembled alternately to form a fuel cell stack. The bipolar plates not only provide structure and physical strength for the fuel cell stack but also electrical conduction between the MEAs.

Graphite and metals are currently used to fabricate bipolar plates for fuel cells. Graphite is a mineral that is the only natural non-metal that has both high electrical and high thermal conductivity. However, graphite plates are not only brittle, but also expensive to manufacture. Thus, graphite bipolar plates are not ideal for fuel cells.

Metal bipolar plates are not ideal either, as corrosion is a major issue for metal bipolar plates. Special coatings are therefore necessary to prevent corrosion of metal bipolar plates. It is therefore desirable to fabricate a bipolar plate that is not only strong and resistant to corrosion, but also economical to manufacture.

### SUMMARY OF THE INVENTION

In accordance with an embodiment, a composite bipolar plate for a fuel cell stack is provided. The bipolar plate includes a metal foil that has a first surface and a second surface. A plurality of parallel rows formed of flexible graphite is deposited across the first surface and a plurality of parallel rows formed of flexible graphite is deposited across the second surface.

In accordance with another embodiment, a method is provided for assembling a fuel cell stack using graphite metal composite bipolar plates. A bipolar plate is formed by providing a metal foil and depositing a plurality of rows of flexible graphite across top and bottom surfaces of the metal foil to form channels between the rows of flexible graphite. A membrane electrode assembly is then provided on each side of the bipolar plate.

### BRIEF DESCRIPTION OF THE DRAWINGS

The invention, together with further objects and advantages thereof, may best be understood by reference to the following description taken in conjunction with the accompanying drawings in which:

FIG. 1 is a top view of a bipolar plate in accordance with an embodiment.

FIG. 2 is a schematic side view of a fuel cell assembly in accordance with an embodiment.

FIG. 3 shows a gasket positioned around the perimeter on the bipolar plate shown in FIG. 1.

FIG. 4 is a flow chart of a method of assembling a fuel cell in accordance with an embodiment.

### DETAILED DESCRIPTION OF EMBODIMENTS

The present invention relates generally to fuel cell systems. Embodiments of composite bipolar plates described herein are robust for use in fuel cell systems and can be manufactured economically. The bipolar plates described herein are composite graphite and metal plates.

According to embodiments described herein, the fuel cells can be polymer electrolyte membrane or proton exchange membrane (PEM) fuel cells having a membrane electrode assembly (MEA). Typically, MEAs and bipolar plates are assembled and stacked alternately to form a fuel cell stack.

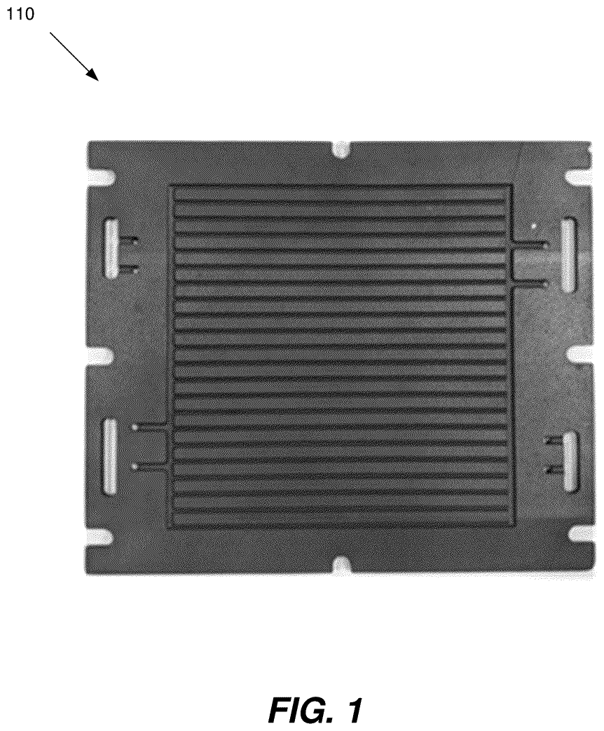

FIG. 1 is a top view of a bipolar plate 110. Bipolar plates are positioned between individual fuel cells to separate them and provide electrical connection between the cells. The bipolar plates also provide physical structure and allow the stacking of individual fuel cells into fuel cell stacks to provide higher voltages. In some embodiments, the fuel cell system is fueled by hydrogen-rich gases produced by reforming methanol, natural gas, or liquefied petroleum gas, etc. In other embodiments, the fuel cell system can be fueled by other fuels, such as hydrogen. It will be understood that any other types of fuel cells can be used in a fuel cell system, including solid acid fuel cells, solid oxide fuel cells, phosphoric acid fuel cells, molten carbonate fuel cells, and alkaline fuel cells.

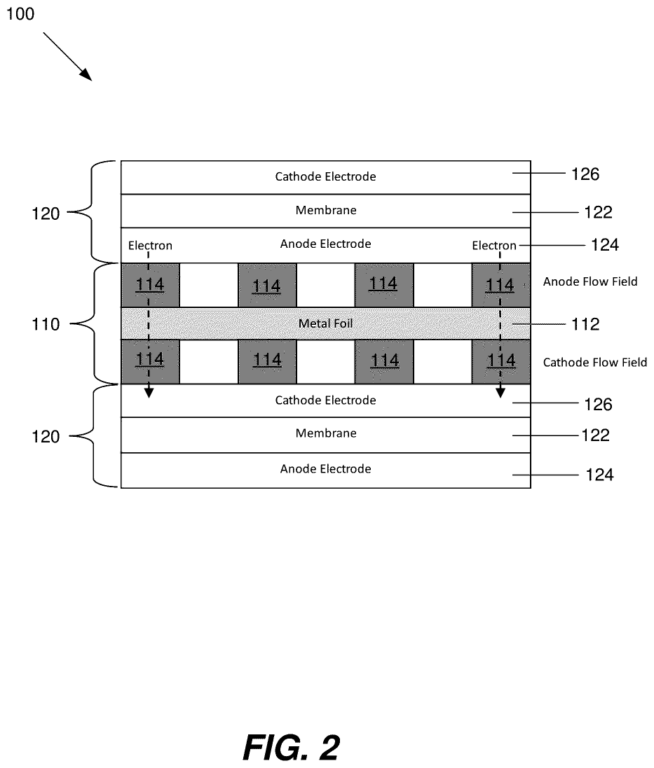

According to an embodiment, composite bipolar plates 110 comprising metal and graphite are provided in a fuel cell assembly 100. As shown in FIG. 2, a metal foil 112 is used as a core of a bipolar plate 110. The metal foil 112 is not only stable in a fuel cell environment, but also improves the flexural strength of the bipolar plate 110.

The bipolar plate 110 comprises the metal foil 112 as well as flexible graphite 114 that is deposited in parallel rows on the metal foil 112 surface on both sides of the metal foil 112 to form anode and cathode flow fields on the surfaces of the bipolar plate 110, as illustrated in FIG. 2. As shown in FIG. 2, the deposited flexible graphite 114 form channels (between the flexible graphite 114) on the bipolar plate 110, which serve as the flow fields that allow gases to flow over the MEA. The flow fields can be formed on the metal foil 112 by over-molding, lamination, or embossing.

Flexible graphite protects the underlying surface of the metal foil 112 from passivation, reduces interfacial contact resistance, and allows electrons to migrate easily from the anode electrode to the cathode electrode via the graphite 114/metal 112 interface of the bipolar plate 110. Thus, flexible graphite maintains good electric conductivity fuel cell.

Tantalum (Ta) is known to be resistive to corrosion. It has shown great potential in fuel cells and electrolyzers with acidic electrolytes at elevated temperatures. Even though tantalum coated metal plates showed excellent corrosion resistance, fuel cell performance of these tantalum plates is not optimal. In early development of phosphoric acid fuel cells, tantalum screen used in electrodes had to be gold-plated to reduce contact resistance. The interfacial contact resistance of tantalum may be the cause of low fuel cell performance. Gold-plating is expensive and therefore not practical.

According to some embodiments, the metal foil 112 of the bipolar plate 110 can be formed of tantalum or tantalum coated metals, such as stainless steel and aluminum. Tantalum foil is commercially available in different thicknesses. A tantalum coating can be deposited on metal substrates by thermal spraying, physical vapor deposition, chemical vapor deposition, and molten salt electrodeposition. According to an embodiment, the metal foil 112 is formed of tantalum and has a thickness in a range of about 0.025 mm to 1.5 mm. According to another embodiment, the metal foil 112 is formed of aluminum, titanium, or stainless steel coated with nickel, chromium nitride, or even a thin layer of conductive carbon.

Flexible graphite (sometimes referred to as graphite foil or expanded graphite) is derived from naturally occurring flake graphite. This flake graphite can be submerged in chromatic and sulfuric acid and then exposed to intense heat to form flexible graphite. The intense heat weakens the strong hexagonal bonds between carbon atoms of the graphite, which is expanded with the weakened bonds.

In fuel cells, in addition to electricity, some energy in the fuels is released as heat and thermal management systems are employed to dissipate the waste heat that is generated to prevent damage to fuel cells from overheating. It will be noted that the high in-plane thermal conductivity of the flexible graphite (280 W/mK) in the bipolar plate 110 also facilitates heat dissipation via edge cooling.

Similar to flexible graphite but more ridged with higher graphite content in the carbon fibers, preformed sheets of carbon from suppliers, such as those supplied by Toray Industries, Japan (TGPH grade), have both high thermal and electronic conductivity, are inert to strong acids and oxidation, and can be quickly pressed to form the channels and lands to make contact with the MEA.

The metal foil 112 is also impermeable to gases. According to embodiments described herein, the web thickness of the bipolar plate 110 can be about 0.050 mm. The graphite metal composite can be used for current collectors. It can replace Grafoil gaskets and gold-plated metal plates, and reduce stack weight. By allowing thin, porous graphite structures of under 1 mm thick, and more preferably under 0.5 mm thick, be employed whereby no densification of the carbon material is necessary to block gasses from crossing over between anode and cathode compartments, very light and compact fuel cell stacks can be fabricated. Furthermore, such weight and volume savings are expected to produce fuel cell stacks capable of mass specific power of >3 kW/kg and volume specific power >3 kW/liter.

As shown in FIG. 2, a membrane electrode assembly (MEA) 120 is on either side of the bipolar plate 110. In a fuel cell stack, bipolar plates 110 and MEAs 120 are assembled alternately. Each MEA 120 includes a membrane 122 sandwiched between an anode electrode 124 and a cathode electrode 126. The MEA 120 is where power is produced in a fuel cell. The MEA 120 produces the electrochemical reaction for separating electrons. A fuel, such as, for example, hydrogen or methanol, diffuses through the membrane 122 from the anode 124 side to the cathode 126 by an oxidant, such as oxygen or air. The oxidant bonds with the fuel and receives the electrons separated from the fuel in the electrochemical reaction. Catalysts embedded in the electrodes 124,126 on each side enable reactions and the membrane 122 allows protons to pass through the membrane while keeping the gases separate, thereby maintaining cell potential, and current is drawn from the cell producing electricity.

In a PEM fuel cell fueled by hydrogen, for example, the membrane 122 allows hydrogen protons to transfer from an anode 124 to a cathode 126 with catalysts on both electrodes 124, 126 to assist in chemical reactions. In this example, hydrogen is provided to the anode 124 and oxygen is provided to the cathode 126. The hydrogen is broken down at the anode 124 into electrons and protons, and the electrons then pass through an electrical circuit connected to the membrane cell to provide electrical power while the protons pass through the membrane 122 to the cathode 126. The electrons and protons combine with oxygen at the cathode 126 to produce water vapor.

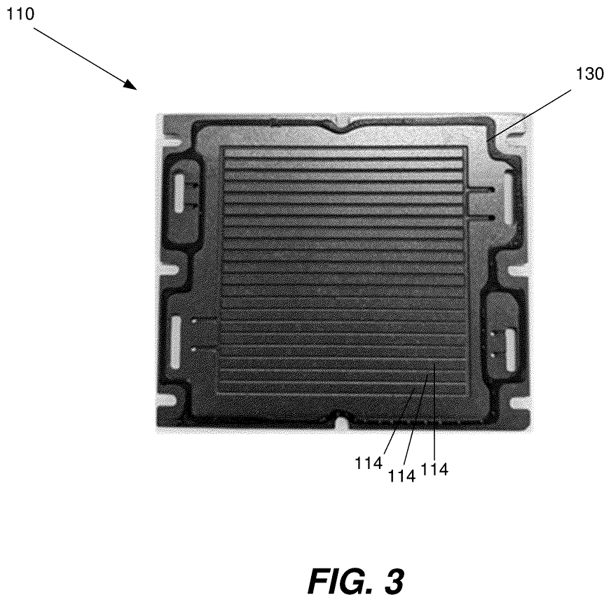

Gaskets are provided to form a reliable gas-tight seal between the bipolar plates and MEAs in a fuel cell stack. In high temperature PEM fuel cells, high temperature plastic films are typically used as gaskets in fuel cell stacks. Typically, the gasket 130 is provided around the perimeter of the bipolar plates 110 (FIG. 3) on both sides of each bipolar plate 110 before the bipolar plates and MEAs are stacked in an alternating fashion. The entire fuel cell stack is then compressed to form a reliable seal between the bipolar plates and the MEAs.

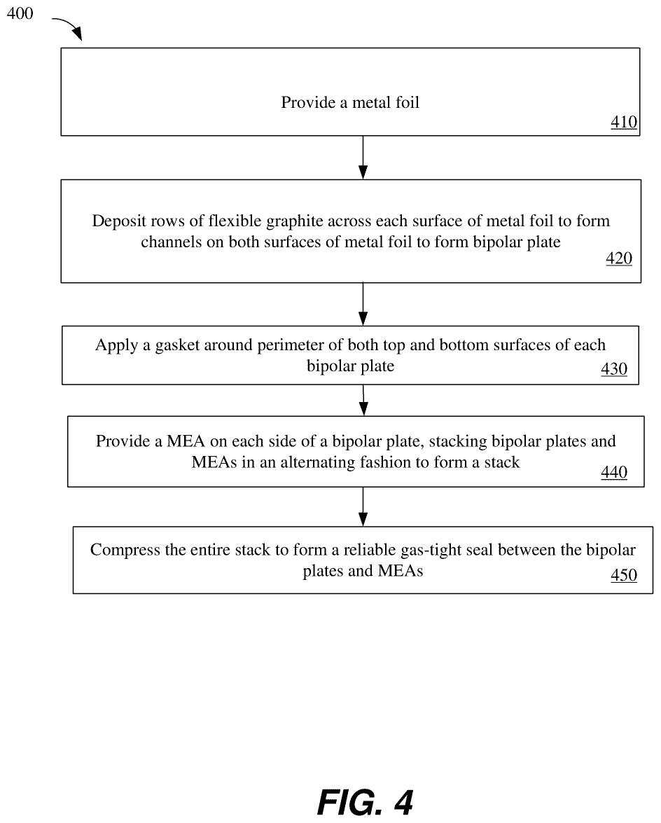

FIG. 4 a flow chart of a method 400 of assembling a fuel cell using graphite metal composite bipolar plates in accordance with an embodiment. In Step 410, a metal foil is provided. In one embodiment, the metal foil is formed of tantalum. According to another embodiment, the metal foil is formed of a metal, such as stainless steel or aluminum, that is coated with tantalum.

In Step 420, to form a bipolar plate, rows of flexible graphite are deposited across each (top and bottom) surface of the metal foil to form channels on both surfaces of metal foil. Channels are formed between the rows of flexible graphite and the channels provide the flow fields for gases. In Step 430, a gasket is applied around the perimeter of both top and bottom surfaces of each bipolar plate.

In Step 440, a MEA is provided on each side of a bipolar plate, stacking bipolar plates and MEAs in an alternating fashion to form a stack. The entire stack is then compressed to form a reliable gas-tight seal between the bipolar plates and MEAs in Step 450.

In view of the foregoing, it should be apparent that the present embodiments are illustrative and not restrictive and the invention is not limited to the details given herein but may be modified within the scope and equivalents of the appended claims.

What is claimed is:

1. A composite bipolar plate for a fuel cell stack, comprising:
a metal foil having a first surface and a second surface;
a plurality of parallel rows formed of flexible graphite across the first surface; and
a plurality of parallel rows formed of flexible graphite across the second surface.

2. The composite bipolar plate as recited in claim 1, wherein the metal foil is formed of tantalum.

3. The composite bipolar plate as recited in claim 1, wherein the metal foil is formed of a metal having a tantalum coating.

4. The composite bipolar plate as recited in claim 3, wherein the metal is stainless steel.

5. The composite bipolar plate as recited in claim 3, wherein the metal is aluminum.

6. The composite bipolar plate as recited in claim 3, wherein the tantalum coating is deposited on the metal by thermal spraying, physical vapor deposition, chemical vapor deposition, or molten salt electrodeposition.

7. The composite bipolar plate as recited in claim 1, wherein the flexible graphite is formed on the first and second surfaces by over-molding, lamination, or embossing.

8. A method of assembling a fuel cell stack using graphite metal composite bipolar plates, the method comprising:
forming a bipolar plate, comprising:
providing a metal foil; and
depositing a plurality of rows of flexible graphite across top and bottom surfaces of the metal foil to form channels between the rows of flexible graphite; and
providing a membrane electrode assembly on each side of the bipolar plate.

9. The method as recited in claim 8, further comprising stacking bipolar plates and membrane electrode assemblies in an alternating fashion to form the fuel cell stack.

10. The method as recited in claim 8, further comprising applying a gasket around a perimeter of each of the top and bottom surfaces of the metal foil before stacking the bipolar plates and membrane electrode assemblies.

11. The method as recited in claim 10, further comprising compressing the fuel cell stack to form a reliable gas-tight seal between the bipolar plates and membrane electrode assemblies after stacking.

12. The method as recited in claim 8, wherein the metal foil is formed of tantalum.

13. The method as recited in claim 8, wherein the metal foil is formed of a metal having a tantalum coating.

14. The method as recited in claim 13, wherein the metal is stainless steel.

15. The method as recited in claim 13, wherein the metal is aluminum.

16. The method as recited in claim 13, wherein the tantalum coating is deposited on the metal by thermal spraying, physical vapor deposition, chemical vapor deposition, or molten salt electrodeposition.

17. The method as recited in claim 8, wherein depositing the plurality of rows of flexible graphite comprises over-molding.

18. The method as recited in claim 8, wherein the metal foil is formed of a metal having a coating over the metal.

19. The metal as recited in claim 18, wherein the metal is aluminum, titanium, or stainless steel.

20. The method as recited in claim 19, wherein the coating comprises nickel, chromium nitride, or conductive carbon.

21. The method as recited in claim 8, wherein depositing the plurality of rows of flexible graphite comprises laminating.

22. The method as recited in claim 8, wherein depositing the plurality of rows of flexible graphite comprises embossing.
